(19) United States
(12) Patent Application Publication
(10) Pub. No.: US 2024/0239426 A1
(43) Pub. Date: Jul. 18, 2024

(54) SYSTEM AND METHOD FOR MOVING ON SLOPING SURFACES

(71) Applicant: BLADERANGER LTD., Ramat Gan (IL)

(72) Inventors: Assaf FRIEDLER, Ramat Gan (IL); Ehud EPSTEIN, Herzliya (IL)

(21) Appl. No.: 18/288,254

(22) PCT Filed: Apr. 28, 2022
(86) PCT No.: PCT/IL2022/050440

§ 371 Date: Oct. 25, 2023

Related U.S. Application Data
(60) Provisional application No. 63/180,731, filed on Apr. 28, 2021.

(51) Int. Cl. B62D 57/024; B62D 55/075

(52) U.S. Cl. CPC B62D 57/024; B62D 55/075

(57) ABSTRACT

A device, system and method for servicing sloped surfaces are disclosed. A mobile service device for servicing surfaces, may include: at least two movable pull chambers spaced apart from each other, and at least one obstacle overcoming element connected to each movable pull chamber, such that, the movable pull chambers are capable of moving in a direction normal to a service surface.

### CROSS-REFERENCE

This application claims the benefit of priority of U.S. Provisional Patent Application No. 63/180,731, filed on Apr. 28, 2021, the content of which is incorporated herein by reference in its entirety.

### FIELD OF THE INVENTION

The present invention relates generally to robotic devices. More specifically, the present invention relates to robotic devices capable of moving on sloping surfaces.

### BACKGROUND

There are many examples of structures that are composed of multiple flat components, that are connected together to form surfaces. For example: solar photovoltaic (PV) installations (“power plants”) are composed of a plurality of solar PV panels, mounted together to form one or more rows of various sizes and shapes. Another example of such structures includes the outer sides of office or residential buildings, which include separate windows mounted to the same wall (sometimes, even forming the wall). Other examples include but are not limited to floors and walls covered in tiles, or made from bricks laid out on top of each other (or next to each other) so as to form a larger surface, mirrors mounted together to direct light towards a specific point.

The term “panel” as used herein may refer to each component which can be used to build the structure. The panels are mounted together in structures that approximate one or more contiguous surfaces (hereinafter, rows). In many applications, panels forming rows as described above have to be serviced (e.g., inspected, painted, checked, monitored, cleaned, or otherwise). For example, solar power panels have to be cleaned from dirt, dust, and all kinds of soiling that interfere with power production. Windows, tiles on walls have to be scrubbed and cleaned, etc.

In building a mobile service device (hereinafter, robot) that moves across rows to service panels, a frequent challenge is found. Rows are often sloped, meaning that they are positioned such that gravity or other forces act against the motion of the robot, pulling it away from the panel, or in opposition to the desired motion of the device. A common solution approach is then to use components mounted on the robot to counter these forces. For example, the robot may have one or more pressure chambers (also referred to as vacuum or suction chambers) that maintain lower pressure which pulls the robot towards the panel (this solution is in common use in various robot window cleaners, and pools cleaners). In some applications, there are alternatives to suction chambers, e.g., electro-magnetic components acting to pull the robot towards panels. In the scope of this application the term “pull chambers” will be used as a general term for all solutions that maintain lower pressure which pulls the robot towards the panel, such as, pressure chambers (e.g., suction chambers, vacuum chambers) and electro-magnetic components action to pull the robot towards panels, as well as any other solution, which pulls the robot towards the panel surface.

Embodiment of the present invention described in this document address a key challenge in building a robot that moves on sloped rows, which are not perfectly smooth, contiguous, or aligned. Indeed, as panels are separate, in practice, any two or more panels put together may have gaps or spaces between them (e.g., vertical and/or horizontal spaces) which render the row not perfectly contiguous as illustrated in FIG. 1A.

In some cases, panels may have a frame differing in height from the panels surface, or mounting devices that hold neighboring panels together (e.g., mechanical fasteners holding the panels down) may not be aligned with the panels surface, or barriers which physically separate one panel from another may create a rugged row surface (as illustrated in FIG. 1B).

In some cases, panels may have angular differences between them, as illustrated, for example, in FIG. 1C.

The cases described above in general terms often prohibit the use of pull chambers. When a chamber passes over a horizontal gap, it loses its pressure (in the case of a pressure chamber) or contact with the panel (in the case of an electromagnetic chamber) and will not pull the robot towards the panel. Moreover, when the robot or pull chamber encounters a vertical gap or difference, no matter the source, it can lose contact with the panel (as it moves to accommodate the new surface height or to overcome the barrier). The robot may also be physically blocked by the height difference, interfering with the smooth motion of the robot.

Robots have been built to service a continuous row when it is horizontal, to vacuum or mop floors. As discussed, when the rows are sloped, gravity and other forces pull the robot away from the panels, and/or in directions other than the intended motion, and thus prohibit servicing the panels composing the row.

There are two approaches to addressing this, in the state of the art: Non-actuated adhesion and actuated adhesion.

Non-actuated adhesion: Depending on the friction coefficient (which may vary with materials and contact area between the robot on and the slope), the friction force may be sufficient to counteract gravity, and allow the robots to service the surface unimpaired. In some cases, specialized materials are used by the robot's component which come in contact with the panels, and which increase the friction coefficient. This requires no expenditure of energy by the robot, nor actuation other than that used for motion. Robotics cleaners for rugs or floors, robots for cleaning horizontal PV panels, are a few examples of robots utilizing non-actuated adhesion.

Actuated Adhesion: In sloped rows where the friction forces are not sufficient, robots may use specialized actuators to adhere themselves to the panel surfaces. A variety of active adhesion methods exist that may be attempted in this case. Their effectiveness and energy expenditure requirements depend on the method, on the surface materials, on the conditions of the surface (e.g., texture, accumulation of dust, or liquids), and ambient environment (e.g., humidity and temperature).

There are two general classes of active adhesion methods.

Anchored methods use actuators to establish one or more fixed immobile adhesion points (termed “anchors”), which supply sufficient friction to counteract gravity, e.g., using pull chambers as anchors. The robot body is then moved relatively to the anchors (typically for a short distance), and then a new set of fixed points are established in the direction of motion. The first set of points is released, allowing the robot body to be moved again. This cycle of “affix- move- affix/release- move-affix/release” repeats.

Examples of devices using static methods include (but are not limited to):

The ECOVACS Raybot, uses suction cups, mounted in fixed locations.

Inverted Robotics robots have actuated suction cups on a moving component in the robot.

The DEMU window cleaning robot has one vacuum chamber providing a fixed point of rotation.

There are several general disadvantages to anchored methods:

They slow down the motion of the robot because of the need to continuously fix new anchors before motion can take place.

They make requirements of the surface which limit their use in the type of applications in which there are vertical gaps or differences. For instance, they require smooth, clean surfaces for the suction to work, while surfaces requiring service are often dirty and/or uneven.

Most importantly, they fail to work when surfaces are physically separated vertically or horizontally, even by short distances, as the position of the adhesion points with respect to each other is fixed, in which case if the next fixed anchor points happen to locate in a gap (distance) between surfaces, no adhesion can form.

Dynamic adhesion methods use actuators that apply continuous force to counteract gravity, but without creating anchored adhesion points. This allows the robot to move smoothly across the surface, without the need to constantly establish and re-establish fixed points of adhesion.

The use of pull chambers as described above is a common example of a dynamic adhesion method. Here, the pull chamber is never allowed to form a static anchor countering all motions, but instead counters just enough of the forces acting against the intended motion of the robot, so as to allow the friction between the robot and panel surface to be sufficient for continuous motion.

Examples of robots applying these methods include window-cleaning robots, which adhere to glass using a suction chamber, where the lower air pressure in the chamber causes the ambient air pressure to hold the robot against the surface of the glass. The air pressure is maintained at a level sufficiently low to counteract gravity on one hand, yet sufficiently high so as to not cause the chamber to be anchored in place.

This allows smooth motion across the surface at relatively higher speeds than in static methods, and may operate also when the surface is unclean, or uneven. However, here again the methods fail when the surfaces are physically separated, i.e., a gap exists between adjacent surfaces. These methods fail because as the robot moves over the gap, the forces they rely on are eliminated:

In the case of suction chambers, the air coming from the gap increases the pressure within the chamber to its ambient level, thus neutralizing the effects of the suction. In the case of magnetic adhesion, the magnetic forces do not exist in the gap, and thus again the chamber will lose its effectiveness.

Thus, there is a need for a robot that can effectively service a collection of surfaces that are separated by short horizontal or vertical distances (“gaps”), which are part of the same row.

### SUMMARY OF THE INVENTION

Some aspects of the present invention relate to a device, system and method for servicing sloped surfaces. According to one embodiment, a mobile service device for servicing surfaces, may include: at least two movable pull chambers spaced apart from each other, and at least one obstacle overcoming element connected to each movable pull chamber, wherein the movable pull chambers are capable of moving in a direction normal to a service surface.

In some embodiments, the at least one obstacle overcoming element is configured to guide a respective pull chamber along the normal direction, during a vaulting of an obstacle.

In some embodiments, the device further comprises at least one vacuum pump in fluid connection to the at least two pull chambers, wherein the at least one vacuum pump is configured to pull the mobile service device towards the service surface. In some embodiments, the at least one vacuum pump is configured to induce a negative pressure on the service surface via the pull chambers, in order to pull the mobile service device towards the service surface.

In some embodiments, each obstacle overcoming element comprises: a rim, circumferentially located around an edge of the respective pull chamber.

In some embodiments, each rim comprises a tube, configured to change a physical property of the rim. In some embodiments, the device further comprises at least one inflation pump in fluid connection to the one or more tubes, wherein the at least one inflation pump is configured to change a pressure characteristic of the one or more tubes.

In some embodiments, the rim further comprises a sloped edge located at a front of the rim, wherein the sloped edge is set at a positive angle with respect to a motion direction of the mobile service device. In some embodiments, each rim is connected to a spring, configured to direct the rim toward the service surface. In some embodiments, the spring is connected to a lower surface of a chassis of the service device. In some embodiments, the spring is connected to a body of the service device, wherein the chassis comprises an opening for each pull chamber, in order to allow independent movement thereof with respect to the normal direction.

In some embodiments, the device further comprises at least one sensor. In some embodiments, the at least one sensor is configured to detect at least one of: a gap between panels of a service surface, an orientation of the mobile service device, an orientation of the pull chambers.

In some embodiments, the device further comprises a controller, configured to perform at least one of: actuating a pull force of the pull chambers, and controlling at least one vacuum pump in fluid connection to the pull chambers. In some embodiments, each of the at least two pull chambers comprises: a first state, comprising a first predefined distance from the serviced surface, and a second state, comprising a second predefined distance from the serviced surface. In some embodiments, actuating between the first and second states is achieved by at least one of: actuating one or more actuators configured to actuate the one or more springs, and inducing a negative pressure on the surface via the pull chambers. In some embodiments, the first predefined distance is greater than zero, and the second predefined distance is equal to zero. In some embodiments, the first predefined distance is equal to zero, and the second predefined distance is greater than zero.

In some embodiments, the device further comprises a service unit. In some embodiments, the service unit is selected from: an autonomous vacuum unit, a panel cleaning unit and a painting unit. In some embodiments, the device further comprises a mobility unit, configured to move the mobile service device.

Some additional aspects may directed to a method of servicing a surface by a mobile service device, the method comprising: adhering the mobile service device to a panel of a first service surface, via at least two pull chambers of the mobile service device; moving the mobile service device on the panel until reaching an obstacle, separating the first service surface from a second service surface; detaching a first pull chamber from the first service surface; moving the mobile service device until the first pull chamber reaches the second service surface; adhering the first pull chamber to the second service surface; moving the mobile service device until the one or more second pull chambers reach the second service surface; and adhering the one or more second pull chambers to the second service surface.

In some embodiments, the method further comprises increasing a pull force of the one or more second pull chambers, while a first pull chamber is detached from the first service surface. In some embodiments, the method further comprises controlling an actuation of at least one spring, comprised in the mobile service device, in order to control a stroke displacement of the one or more pull chambers. In some embodiments, the method further comprises controlling at least one pump, in fluid connection to the one or more pull chambers, in order to induce suction on the one or more service surfaces.

Some aspects of the invention may be directed to a mobile service device for servicing surfaces, comprising: at least two movable pull chambers, spaced apart from each other, and at least one rim, circumferentially located around an edge of the respective pull chamber, wherein the rim comprises at least one sloped edge set at a positive angle with respect to a motion direction of the mobile service device, and wherein the movable pull chambers are capable of moving in a direction normal to a service surface.

In some embodiments, each rim is connected to a spring, configured to direct the rim toward the service surface. In some embodiments, the spring is connected to a lower surface of a chassis of the service device. In some embodiments, the spring is connected to a body of the service device, wherein the chassis comprises an opening for each pull chamber, in order to allow independent movement thereof with respect to the normal direction.

In some embodiments, the device further comprises at least one vacuum pump in fluid connection to the at least two pull chambers, wherein the at least one vacuum pump is configured to pull the mobile service device towards the service surface. In some embodiments, the at least one vacuum pump is configured to induce a negative pressure on the service surface via the pull chambers, in order to pull the mobile service device towards In some embodiments, the device further comprises a controller, configured to perform at least one of: actuating a pull force of the pull chambers, and controlling at least one vacuum pump in fluid connection to the pull chambers. In some embodiments, each of the at least two pull chambers comprises: a first state, comprising a first predefined distance from the serviced surface, and a second state, comprising a second predefined distance from the serviced surface. In some embodiments, actuating between the first and second states is achieved by at least one of: actuating one or more actuators configured to actuate the one or more springs, and inducing a negative pressure on the surface via the pull chambers. In some embodiments, the first predefined distance is greater than zero, and the second predefined distance is equal to zero. In some embodiments, the first predefined distance is equal to zero, and the second predefined distance is greater than zero.

In some embodiments, the device further comprises a service unit. In some embodiments, the service unit is selected from: an autonomous vacuum unit, a panel cleaning unit and a painting unit. In some embodiments, the device further comprises a mobility unit, configured to move the mobile service device.

Some additional aspects of the invention may be directed to a mobile service device for servicing surfaces, comprising: at least two movable pull chambers, spaced apart from each other, and at least one rim, circumferentially located around an edge of the respective pull chamber, wherein the rim comprises a tube configured to change a physical property of the rim, and wherein the movable pull chambers are capable of moving in a direction normal to a service surface.

In some embodiments, the tube is a closed hollow flexible tube and the physical property is a pressure within the tube. In some embodiments, the tube is a closed flexible tube and the physical property is a shape of the tube.

In some embodiments, the device further comprises at least one vacuum pump in fluid connection to the at least two pull chambers, wherein the at least one vacuum pump is configured to pull the mobile service device towards the service surface. In some embodiments, the at least one vacuum pump is configured to induce a negative pressure on the service surface via the pull chambers, in order to pull the mobile service device towards In some embodiments, the device further comprises a controller, configured to perform at least one of: actuating a pull force of the pull chambers, and controlling at least one vacuum pump in fluid connection to the pull chambers. In some embodiments, each of the at least two pull chambers comprises: a first state, comprising a first predefined distance from the serviced surface, and a second state, comprising a second predefined distance from the serviced surface. In some embodiments, actuating between the first and second states is achieved by at least one of: actuating one or more actuators configured to actuate the one or more springs, and inducing a negative pressure on the surface via the pull chambers. In some embodiments, the first predefined distance is greater than zero, and the second predefined distance is equal to zero. In some embodiments, the first predefined distance is equal to zero, and the second predefined distance is greater than zero.

In some embodiments, the device further comprises a service unit. In some embodiments, the service unit is selected from: an autonomous vacuum unit, a panel cleaning unit and a painting unit. In some embodiments, the device further comprises a mobility unit, configured to move the mobile service device.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIGS. 1A-1C are illustrations of typical misalignment situations of neighboring panels in a row;

FIG. 2 is a schematic illustration of a bottom and side views of pull chamber with an obstacle overcoming element according to some embodiments of the present invention;

FIG. 3 shows schematic illustrations of obstacles overcoming processes according to some embodiments;

FIG. 4 is a schematic illustration of an obstacle overcoming mechanism for mobile service devices, comprising a tube and process according to some embodiments of the present invention;

FIGS. 5A and 5B are schematic illustrations of mobile service devices having obstacle overcoming mechanisms comprising a rim according to some embodiments;

FIGS. 6A, 6B, 6C, and 6D show different possible configurations of a plurality of chambers according to some embodiments;

FIGS. 7A, 7B and 7C are illustrations of a mobile service device according to some embodiments of the invention;

FIGS. 8A, 8B, 8C and 8D are illustrations of another mobile service device according to some embodiments of the invention;

FIG. 9 is a block diagram of a mobile service device according to some embodiments of the invention;

FIG. 10 is a flowchart of a method of servicing a sloped surface by a mobile service device according to some embodiments of the present invention.

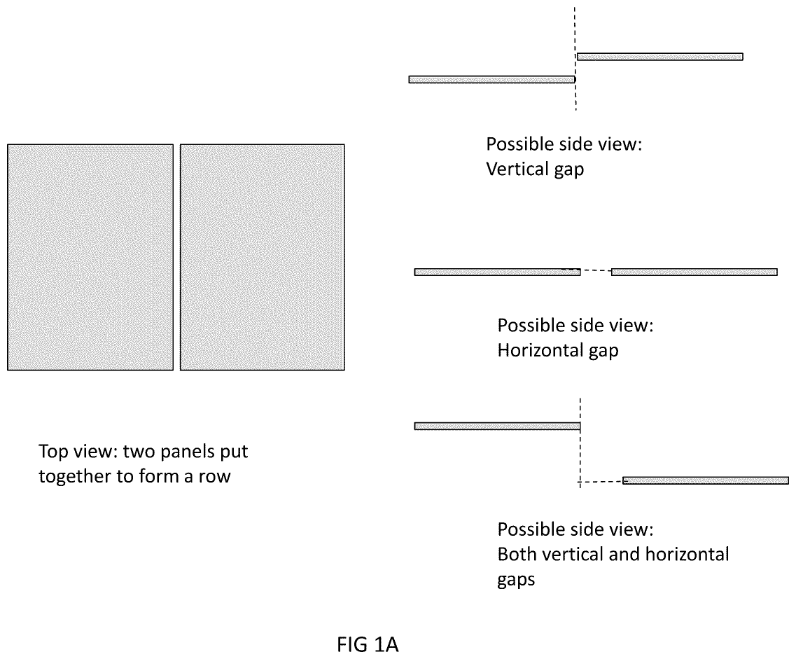

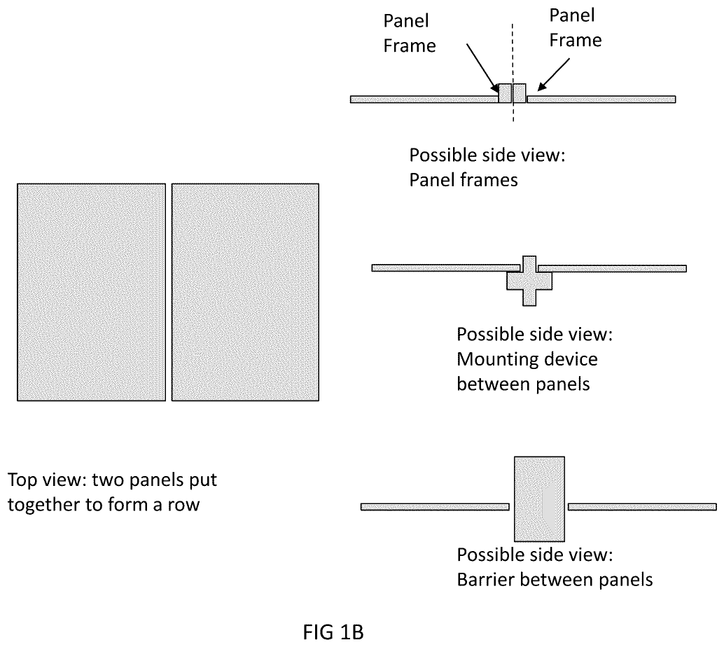

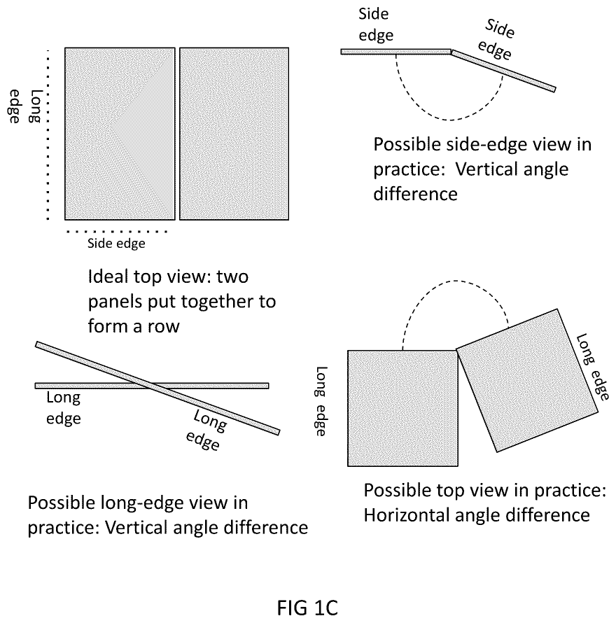

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

For the pull chambers to overcome vertical gaps and barriers, there needs to be a mechanism which adjusts the chamber's vertical position with respect to the panel surface, when encountering a vertical gap or barrier. We present several examples of such mechanisms.

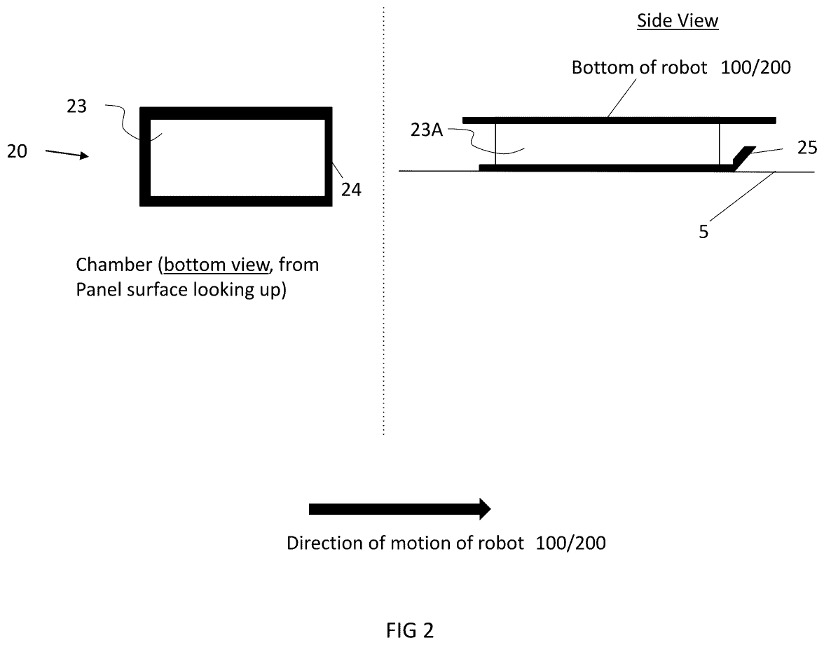

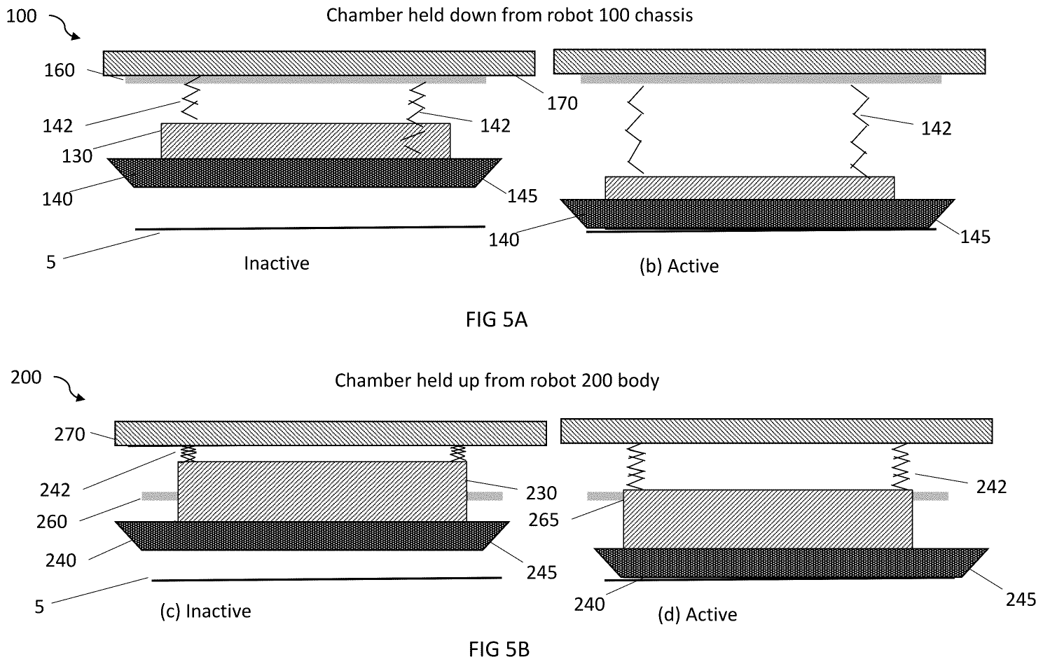

Reference is now made to FIG. 2 which shows a nonlimiting example of a mechanism 20 for overcoming obstacles (e.g., gaps, barriers and the like) between neighboring service surface, such as, panels 5. Mechanism 20 may be included in a mobile service device 100/200 (e.g., a robot). Detailed disclosure of mobile services devices is given with respect to FIGS. 5, 7 and 8. Mechanism 20 may have a movable pull chamber 23 in constant contact with the service surface of the panel 5. Chamber 23 is connected to at least one obstacle overcoming element 24. Element 24 may be a rim circumferentially located around an edge of pull chamber 23. In some embodiments, the rim further comprises a sloped edge 25 located at a front of the rim, wherein sloped edge 25 is set at a positive angle with respect to a motion direction of the mobile service device which allow them to overcome vertical differences and barriers in forward motion. The sides 23A of chamber 23, from the rim up to the bottom of the mobile service device 202, may be made from flexible materials acting as a spring, pushing the rim 24 onto the panel surface 5.

According to some embodiments, the rim may be positively angled in the direction of motion of the mobile service device. FIG. 2 shows a single angle in the direction of the motion, since the mobile service device is traveling in only one direction. It should be appreciated, however, that the mobile service device can move in other directions, and the sled rims may be angled in those directions as well. At the extreme, for an omnidirectional mobile service device, the chamber rim can be round, with an angle facing up away from the center of the chamber.

In some embodiments, when the chamber is inactive, the rim allows it to slide across the surface of panels 5. When it is activated, the sled rims are in contact with the panel surface allowing the chamber to pull the mobile service device bottom towards the panel surface. For example, if the pull chamber works by creating lower pressure within the chamber (suction), the sled rims inhibit the flow of air from outside the chamber into it, creating lower pressure within the chamber.

In some embodiments, as a vertical gap or barrier is encountered, the angled rim of the sled meets it, and this causes the sled rim to push up towards the bottom of the mobile service device. As the mobile service device may continue to move, the sled continues to rise above the barrier, and until it is overcome. When the chamber moves up, it loses contact with the panel surface, and may therefore lose its lower pressure momentarily, until the barrier is passed.

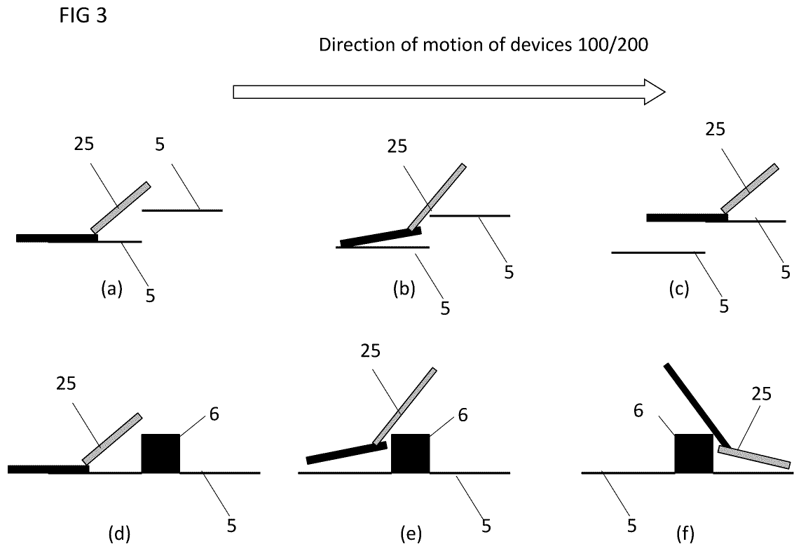

FIG. 3 shows an obstacle overcoming process according to some embodiments of the invention. The sled's (e.g., rim's) angled front 25 is shown in light grey. FIGS. 3a-3c show the progression of the sled as the mobile service device moves. FIG. 3a shows the sled on the panel 5 surface, before meeting the gap vertical difference. FIG. 3b shows the sled sliding up the vertical gap. FIG. 3c shows the sled becoming stable on the new panel surface. FIGS. 3d-3f show the progression of the sled similarly, but when encountering a vertical barrier/obstacle 6.

### Sliding Chamber, Flexible Rim/Inflatable Rim

The mechanism in the above example uses rigid sleds, which maintain the angle of attack towards the direction of motion. When the sled begins sliding up, the rest of the chamber rim rises up with it, as can be seen in FIGS. 3b and 3e. Example mechanism 2 avoids this behavior.

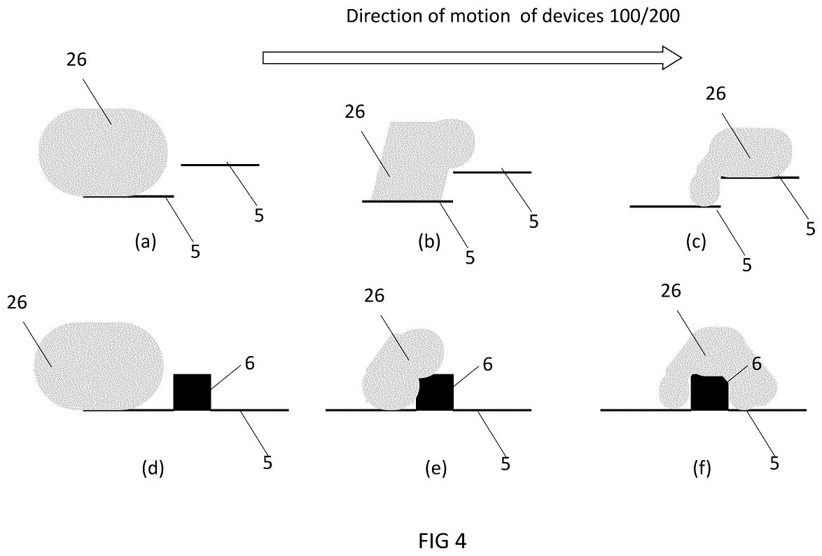

Reference is now made to FIG. 4 which show a different mechanism 20 for overcoming obstacles according to some embodiments of the invention.

In some embodiments, rims 26 different mechanism 20 of devices 100/200. Rims 26 may be are round, flexible, fillable and/or inflatable. The inflatable sides may be filled with air, gas, liquids, sand or any other flowing media. For example, when rim 26 is filled with air, the air may be at a pressure slightly below ambient, so that the vertical space (or barrier) push against the front of the round chamber, causing the air in it to compress towards the back. As a result, the chamber sides may essentially adapt to the shape of the barrier, without raising the chamber off the panel surface as much as in the example above. The pressure within the inflatable sides may be controlled actively, by pumping air in or out into the sides, to adjust the behavior of the sides when encountering a barrier, as

FIGS. 4a-4c show the progression of the process as a device 100/200, such as a mobile service device encounters a vertical gap between surfaces 5. FIGS. 4d-4f show similarly an encounter with a vertical barrier/obstacle 6.

### Hovering Chamber

In some embodiments, the mechanism may put the chamber above the panel surface, so it is normally not in contact with the panel surface. Instead, it is kept hovering from the bottom of the mobile service device above the panel surface until it is activated.

Reference is now made to FIGS. 5A and 5B which are illustrations of mobile service devices for servicing surfaces according to some embodiments of the invention. Each one of devices 100 or 200 illustrated in FIGS. 5A and 5B utilizes a different mechanism in which a pull chambers 130 or 230 can be kept hovering above surface 5.

In some embodiments, device 100, illustrated in FIG. 5A, may include at least one movable pull chamber 130 and at least one rim 140, circumferentially located around an edge of pull chamber 130, as illustrated in FIGS. 2, 7 and 8, wherein the rim comprises at least one sloped edge 145 set at a positive angle with respect to a motion direction of mobile service device 100. In some embodiments, movable pull chamber 130 is capable of moving in a direction normal to service surface 5. In some embodiments, either rim 140 or pull chamber 130 are connected to at least one spring 142, and wherein at least one spring 142 configured to direct rim 140 toward service surface 5. In some embodiments, at least one spring 142 is connected to a lower surface of a chassis 160 of service device 100. In some embodiments, device 100 may further include a body 170 that may include a service unit, configured to act on surface 5 and may be selected from: an autonomous vacuum unit, a panel cleaning unit and the like.

In some embodiments, device 200, illustrated in FIG. 5B, may include at least one movable pull chamber 230 and at least one rim 240, circumferentially located around an edge of pull chamber 230, as illustrated in FIGS. 2, 7 and 8, wherein the rim comprises at least one sloped edge 245 set at a positive angle with respect to a motion direction of mobile service device 200. In some embodiments, movable pull chamber 230 is capable of moving in a direction normal to service surface 5. In some embodiments, either rim 240 or pull chamber 230 are connected to at least one spring 242, and wherein at least one spring 242 configured to direct rim 240 toward service surface 5. In some embodiments, at least one spring 242 is connected to a body 270 of service device 200, wherein a chassis 260 comprises an opening 265 for each pull chamber 230, in order to allow independent movement thereof with respect to the normal direction to surface 5. In some embodiments, body 270 that may include a service unit, configured to act on surface 5 and may be selected from: an autonomous vacuum unit, a panel cleaning unit and the like.

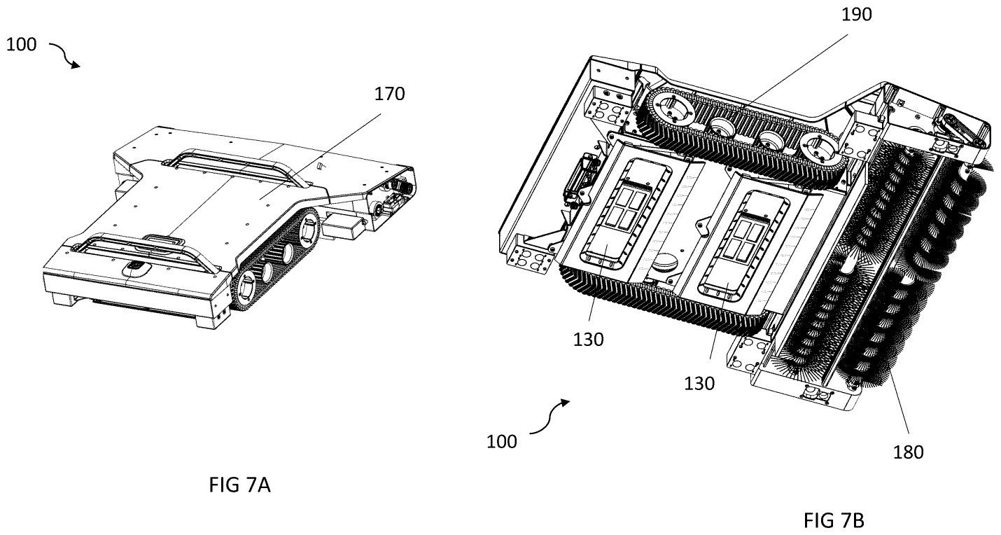

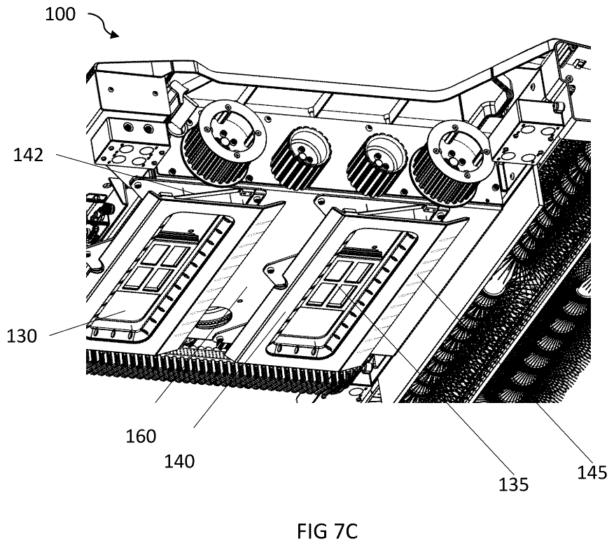

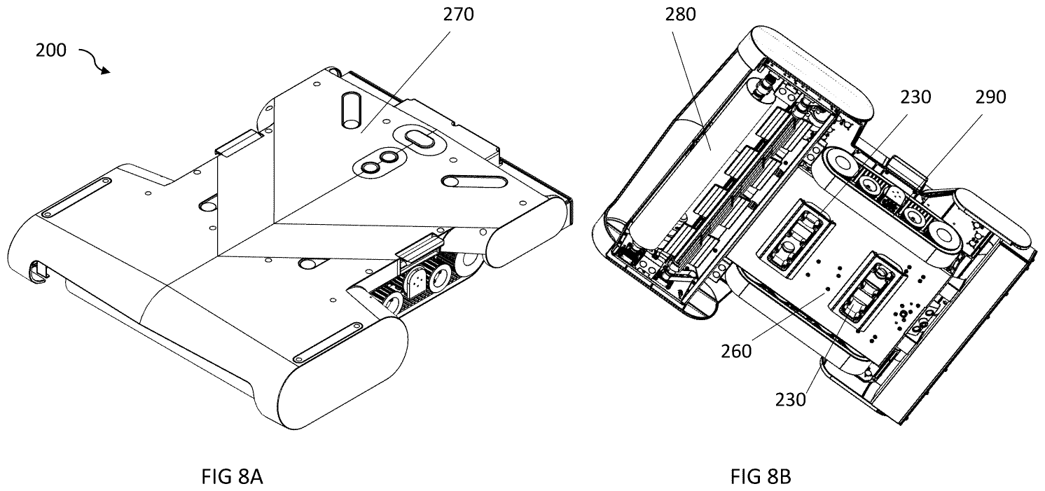

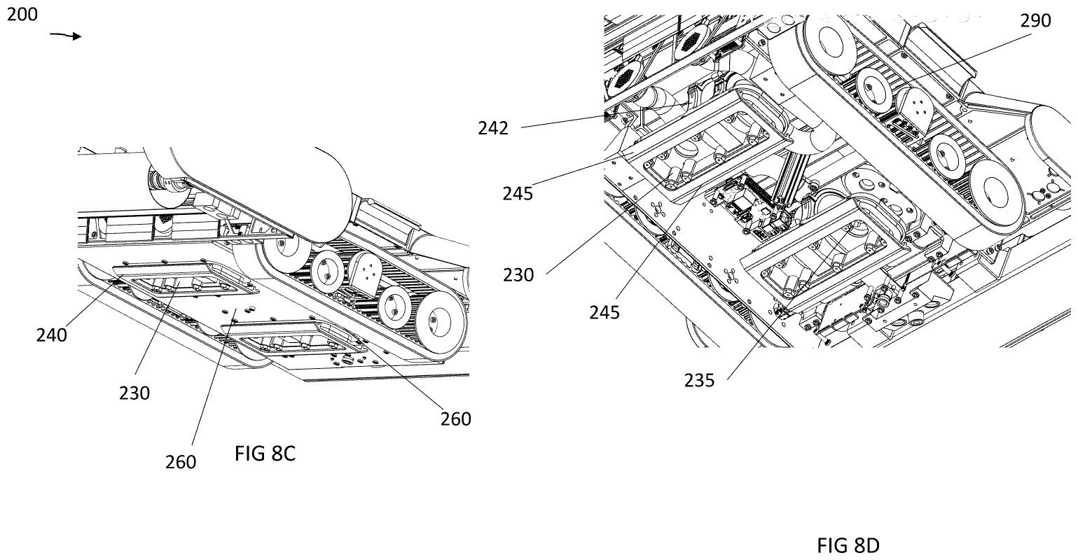

In some embodiments, service devices 100 and 200 may include mobility unit, configured to move the mobile service device, illustrated and discussed with respect to FIGS. 7 and 8.

In a first nonlimiting example, pull chamber 130 may be kept hanging from the bottom of devices 100 (e.g., from chassis 160) by springs 142 that keep the chamber at a fixed distance above surface 5. When chamber 130 is activated, the chamber may be pulled towards panel 5 surface, against the force of springs 142. In a second nonlimiting example of device 200, pull chamber 230 may be held inside device 200, protruding from an opening 265 in chassis 260, where springs 242 push chamber 230 up from chassis 260 back into device 200 belly. Activation of pull chamber 230 may pull the chamber towards panel surface 5. In both cases, the rim of the hovering chamber is shaped as an upwards-facing angle, similarly to the above example.

In some embodiments, if the vertical gap or barrier is encountered when the hovering chamber is inactive, it will either be above the vertical difference (thus not affected by it), or it will encounter it head on. In which case, because there no contact between the chamber and the surface, the angled rim 140/240 (similarly to the mechanism in the above example) may allow it to slide up over the barrier or vertical gap.

In some embodiments, when the vertical gap or barrier is encountered when hovering chamber 130/230 is active, the chamber is pulled towards surface 5, and acts just as in the above example.

Some aspects of the invention may be directed to an actuated dynamic adhesion method that works across horizontal gaps.

In some embodiments, the actuated adhesion method may work across horizontal gaps between panels, by utilizing multiple pull chambers positioned in the direction of the motion. The chambers may be separated from each other at a distance that is larger than the maximal allowed horizontal gap (the maximal distance separating two nearby surfaces).

In some embodiments, given a motion direction for the service device, the pull chambers on the axis of motion, are referred, as front chambers and back chambers. When the service device moves across a gap, and as long as the closest points on the rims of front and back chambers in the direction of motion are separated from each other by a distance equal or smaller than the gap, then the loss of sub-pressure in the pull chambers positioned over the gap is countered by the existence of sub-pressure in other chambers not positioned over the gap. Therefore, the mobile service device may not lose its counter-gravity force, and may continue to advance.

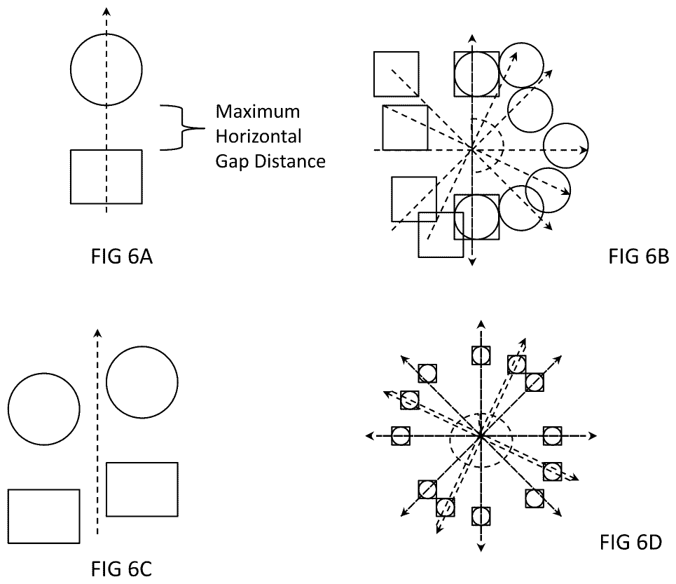

Reference is now made to FIGS. 6A, 6B, 6C, and 6D illustrate various possible configurations. In all, dotted arrows show the direction of motion. Chambers are illustrated as either circles or squares: the actual shape of the rim of the chamber is not important. Squares and circles are used to distinguish between front chambers (e.g., with respect to the expected direction of motion) that are denoted as circles and back chambers (e.g., with respect to the expected direction of motion) that are marked as squares.

In FIG. 6A, a two-chamber configuration is illustrated, with a single direction of motion. The distance between the closest points on the rim of the front (circle) and back (square) chambers is shown explicitly, and denoted maximum horizontal gap distance. This distance is determined by the largest gap that is encountered in the application of the invention.

In FIG. 6C, a single direction of motion is illustrated as well. In some embodiments, the service device may include multiple front chambers (denoted as circles) and multiple back chambers. The number and size of back and front chambers does not need to be the same. Also, the position of the front chambers with respect to each other (and analogously, the back chambers with respect to each other), need not be identical (drawing C shows a staggered position).

In FIG. 6B, a configuration that facilitates motion in multiple directions is illustrated. The dotted arrows pointing right serve to illustrate that in face any direction heading right, along 180 degrees (top to bottom) is valid. Here, two chambers (up and bottom of the vertical axis) may serve as either front or back chambers, depending on the direction of motion. Other chambers on the right may be only front chambers, and their counterparts on the left side of the vertical axis may serve only as back chambers.

In FIG. 6D, the configuration of FIG. 6B is extended, by arranging multiple chambers in a quasi-circular or ellipsoidal pattern (as should be understood by one skilled in the art, any polygon shape may be used, where chambers are positioned in the vertices of the polygon). Therefore, omni-directional motion of the mobile service device is supported, i.e., motion in any direction.

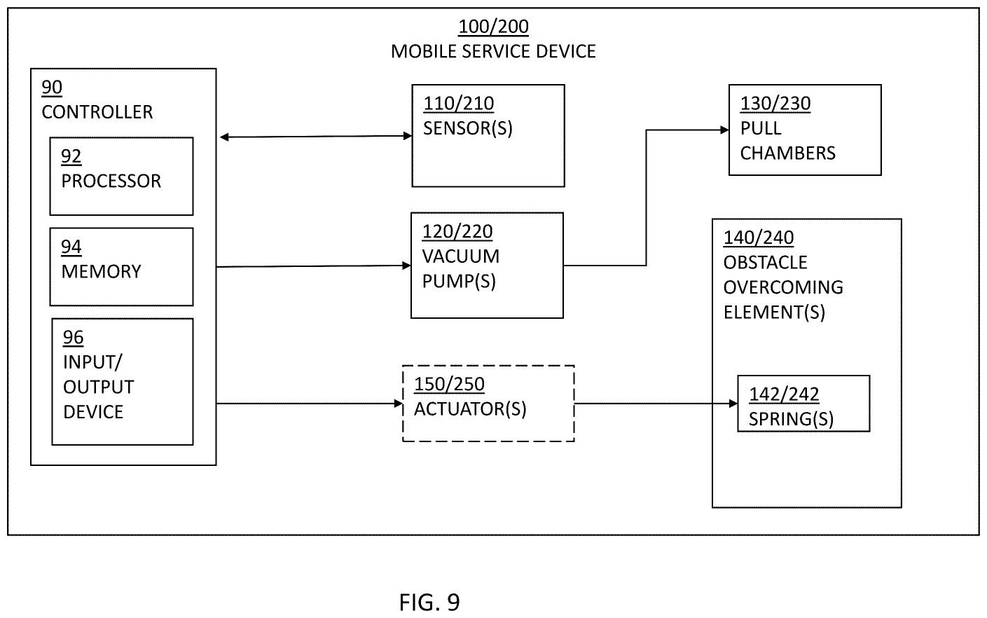

According to some embodiments of the present invention, all previously described embodiments may further include one or more sensors. According to some embodiments, previously described embodiments may further include a controller and control algorithms, as discussed with respect to FIG. 9.

According to some embodiments one or more sensors may be positioned at a location on the mobile service device to provide indication of the existence of a gap between panels in the direction of motion of the mobile service device. According to some embodiments, the one or more sensors may also measure the size of the gap, so as to improve control of the sub-pressure in the chambers ahead of time. According to some embodiments, the distance between pull chambers may be adjusted according to the identified gap size. In other embodiments, if the gap size is bigger that the distance between chambers, the service device may be prevented from continuing in the direction of the gap.

According to some embodiments, the controller may switch off activation of pull chambers that are over a gap, to save energy. For example, switch off the suction of air from the chambers that are moving over the gap, to reduce energy use, as well as to increasing the pulling power of the pull chamber to compensate for the reduction of pull from chambers that are currently over a gap or barrier. For example, increasing the suction of air from chambers that are above the surface, as others are moving over the gap, so as to compensate for the reduction in service device force.

According to some embodiments, the service device may include one or more orientation sensors to detect the angle of the slope. In some embodiments, the controller may increase or decrease the pulling forces of the chamber, (e.g., the suction of air of chambers) based on the determined slope of the surface and/or indications of slipping, so as to optimize the use of energy and counter-forces to gravity, while allowing for mobile service device motion in the intended direction.

In some embodiments, the chambers may be placed on moving actuators, so as to allow control of the distance between them, even when the service device is moving.

The use of maximal pulling force (e.g., suction of air) from one chamber, and reduction from another, according to some embodiments may create an artificial rotation point for the mobile service device, allowing the mobile service device to rotate about the maximal power chamber, thus optimizing its turning radius and velocity.

### Service Devices

Reference is now made to FIGS. 7A, 7B, and 7C which are detailed illustrations of top view, bottom view an enlarged bottom view of a nonlimiting example for mobile service device for servicing surfaces according to some embodiments of the invention. Mobile service device 100 may include at least two movable pull chambers 130 spaced apart from each other and at least one obstacle overcoming element, for example, rim 140 connected to each movable pull chamber 130. As should be understood by one skilled in the art, device 100 may include other obstacle overcoming elements, for example, rims, 24, 26 and 240. In some embodiments, movable pull chambers 130 are capable of moving in a direction normal to a service surface, for example, the surface of panel 5.

In some embodiments, rim 140 or any other obstacle overcoming element is configured to guide a respective pull chamber along the normal direction with respect to the service surface, during a vaulting of an obstacle, for example, obstacle 6. In some embodiments, each rim 140 is circumferentially located around an edge of a respective pull chamber 130.

In some embodiments, Mobile service device 100 may further include at least one vacuum pump, illustrated in FIG. 9, in fluid connection to at least two pull chambers 130, for example via opening 135, wherein the at least one vacuum pump is configured to pull mobile service device 100 towards the service surface. In some embodiments, the at least one vacuum pump is configured to induce a negative pressure on the service surface via pull chambers 130, in order to pull mobile service device 100 towards the service surface.

In some embodiments, rim 140 may further comprises a sloped edge 145 located at a front of rim 140, wherein sloped edge 145 is set at a positive angle with respect to a motion direction of mobile service device 100. In some embodiments, rim 140 may include more than one sloped edge 145, allowing mobile service device 100 to overcome obstacles in more than one direction. In some embodiments, each rim 140 is connected to a spring 142 configured to direct rim 140 toward the service surface. In some embodiments, springs 142, may be a leaf spring, as illustrated, or any other suitable spring. In some embodiments, spring 142 may be connected directly to rim 140, as illustrated. In some embodiments, springs 142 may be connected to pull chamber 130 with is connected to rim 140, as illustrated in FIG. 5A.

In some embodiments, one or more springs 142 are connected to a lower surface of chassis 160 of service device 100. In such configuration the maximal normal movement of rim 140 with respect to the service surface is the distance between the surface and the lower surface of chassis 160.

In some embodiments, each of the at least two pull chambers 130 may be in one of two states, as discussed with respect to FIG. 5A. In some embodiments, a first state (e.g., an inactive state), comprising a first predefined distance from the serviced surface and a second state (e.g., an active state), comprising a second predefined distance from the serviced surface. In some embodiments, the first predefined distance is greater than zero, and the second predefined distance is equal to zero or vice versa. In some embodiments, actuating between the first and second states is achieved by at least one of: actuating one or more actuators configured to actuate the one or more springs 142, and inducing a negative pressure on the surface via pull chambers 130.

In some embodiments, service device 100 may further include a body 170, a service unit 180, and a mobility unit 190. Service unit 180 may be configured to provide a service, such as, cleaning, vacuuming, painting, and the like to the service surface. In the nonlimiting example illustrated in FIG. 7B, service unit 180 includes a set of rotating brushes configured to clean panels, such as solar panels.

Mobility unit 190, may include any component that is configured to move the mobile service device. For example, mobility unit 190 may include an engine (e.g., electric engine, hydraulic engine, fuel engine etc.) a gear and either tacks (as illustrated) or wheels.

Reference is now made to FIGS. 8A, 8B, 8C and 8D which are detailed illustrations of top view, bottom view an enlarged bottom views of a nonlimiting example for mobile service device for servicing surfaces according to some embodiments of the invention. Mobile service device 200 may include at least two movable pull chambers 230 spaced apart from each other and at least one obstacle overcoming element, for example, rim 240 connected to each movable pull chamber 230. As should be understood by one skilled in the art, device 200 may include other obstacle overcoming elements, for example, rims, 24, 26 and 140. In some embodiments, movable pull chambers 230 are capable of moving in a direction normal to a service surface, for example, the surface of panel 5.

In some embodiments, rim 240 or any other obstacle overcoming element is configured to guide a respective pull chamber along the normal direction with respect to the service surface, during a vaulting of an obstacle, for example, obstacle 6. In some embodiments, each rim 240 is circumferentially located around an edge of a respective pull chamber 230.

In some embodiments, mobile service device 200 may further include at least one vacuum pump, illustrated in FIG. 9, in fluid connection to at least two pull chambers 230, for example via opening 235, wherein the at least one vacuum pump is configured to pull mobile service device 100 towards the service surface. In some embodiments, the at least one vacuum pump is configured to induce a negative pressure on the service surface via pull chambers 230, in order to pull mobile service device 200 towards the service surface.

In some embodiments, rim 240 may further comprises a sloped edge 245 located at a front of rim 240, wherein sloped edge 245 is set at a positive angle with respect to a motion direction of mobile service device 200. In some embodiments, rim 240 may include more than one sloped edge 245, for example, the two sloped edges 245 illustrated, allowing mobile service device 200 to overcome obstacles in more than one direction. In some embodiments, each rim 240 is connected to at least one spring 242 configured to direct rim 240 toward the service surface. In some embodiments, springs 242, may be any suitable spring. In some embodiments, spring 242 may be connected directly to rim 240, as illustrated. In some embodiments, springs 242 may be connected to pull chamber 230 with is connected to rim 240, as illustrated in FIG. 5B.

In some embodiments, one or more springs 242 are connected to body 270 of the service device, wherein chassis 260 comprises an opening 265 for each pull chamber 265, in order to allow independent movement thereof with respect to the normal direction.

In some embodiments, each of the at least two pull chambers 230 may be in one of two states, as discussed with respect to FIG. 5B. In some embodiments, a first state (e.g., an inactive state), comprising a first predefined distance from the serviced surface and a second state (e.g., an active state), comprising a second predefined distance from the serviced surface. In some embodiments, the first predefined distance is greater than zero, and the second predefined distance is equal to zero or vice versa. In some embodiments, actuating between the first and second states is achieved by at least one of: actuating one or more actuators configured to actuate the one or more springs 242, and inducing a negative pressure on the surface via pull chambers 230.

In some embodiments, service device 200 may further include a body 270, a service unit 280, and a mobility unit 290. Service unit 280 may be configured to provide a service, such as, cleaning, vacuuming, painting, and the like to the service surface. In the nonlimiting example illustrated in FIG. 8B, service unit 280 includes a roller and a wiper configured to clean panels, such as solar panels.

Mobility unit 290, may include any component that is configured to move the mobile service device. For example, mobility unit 290 may include an engine (e.g., electric engine, hydraulic engine, fuel engine etc.) a gear and either tacks (as illustrated) or wheels.

In some embodiments, the rims of devices 100 or device 200 may include a tube, configured to change a physical property of the rim for example, rim 26. In some embodiments, devices 100 or device 200 may further include at least one inflation pump in fluid connection to the one or more tubes, wherein the at least one inflation pump is configured to change a pressure characteristic of the one or more tubes.

### System and Method of Operation

Reference is now made to FIG. 9 which is a block diagram of a mobile service device according to some embodiments of the invention. In some embodiments, mobile service devices 100 or 200 may further include a controller 90 configured to perform at least one of: actuating a pull force of pull chambers 130 or 230, and controlling at least one vacuum pump 120 or 220 in fluid connection to a corresponding pull chambers 130 or 230. In some embodiments, controller 90 may include a processor 92 which may be any processing platform, such as, a central processing unit (CPU) processor, a chip or any suitable computing or computational device, that may execute instructions stored in memory 94.

Memory 94 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 94 may be or may include a plurality of possibly different memory units. Memory 94 may be a computer or processor non-transitory readable medium, or a computer non-transitory storage medium, e.g., a RAM. In one embodiment, a non-transitory storage medium such as memory 94, a hard disk drive, another storage device, etc. may store instructions or code which when executed by a processor may cause the processor to carry out methods as described herein.

Controller 90 may further include any umber or input/output devices 96. Input devices 96 may be or may include any suitable input devices, components or systems, e.g., a detachable keyboard or keypad, a mouse and the like. Output devices 96 may include one or more (possibly detachable) displays or monitors, speakers and/or any other suitable output devices. Any applicable input/output (I/O) devices 96 may be connected to controller 90. For example, a wired or wireless network interface card (NIC), a universal serial bus (USB) device or external hard drive may be included in input/output devices 96.

In some embodiments, a single vacuum pump may provide suction to more than one pull chamber 130 or 230 and controller 90 may control a switch (not illustrated) to actuate between at least two pull chambers 130 or 230. In some embodiments, each pull chamber 130 or 230 may be in fluid connection to a single vacuum pump 120 or 220 and controller 90 may actuate between the pumps.

In some embodiments, mobile service device 100 or 200 may further include sensors 110 or 210. In some embodiments, the at least one sensor 110 or 210 is configured to detect at least one of: a gap between panels of a service surface, an orientation of the mobile service device, an orientation of the pull chambers and the like. Sensor 110 or 210 may be, a camera, a distance sensor, a gyroscope, and the like.

In some embodiments, mobile service device 100 or 200 may further include actuators 150 or 250 configured to control the movement of springs 142 or 242. The actuators may lock the movement of the springs, limit the movement of the springs.

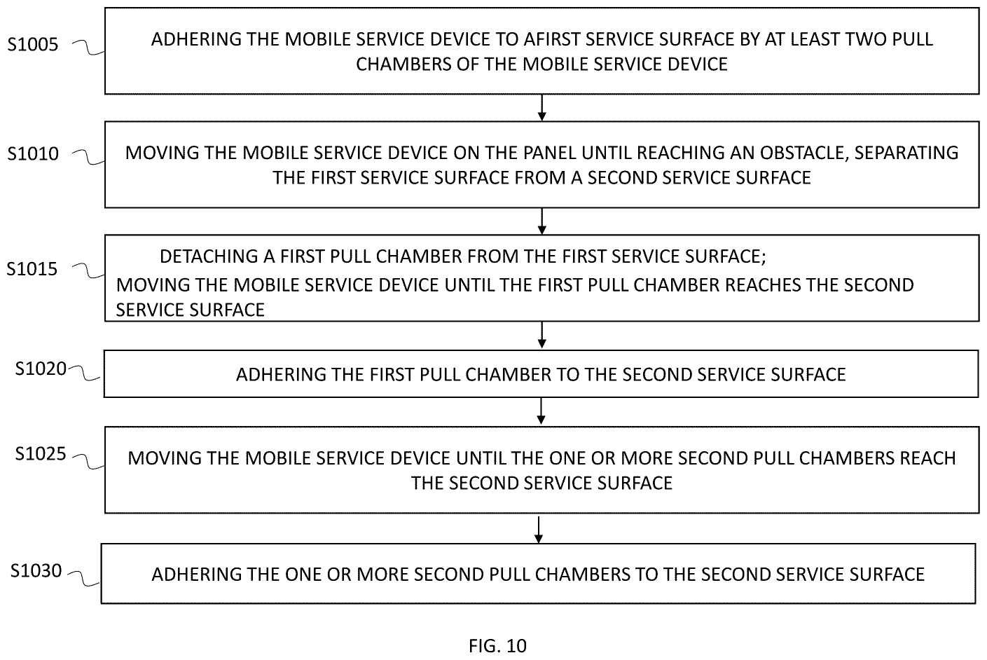

Reference is now made to FIG. 10 which is a flowchart of a method of servicing a sloped surface by a mobile service device. The method may include at step 1005 actively adhering the mobile service device (e.g., devices 100 and 200) to a panel 5 of a first service surface, via at least two pull chambers (e.g., chambers 130 and 230) of the mobile service device.

In step 1010, the mobile service device may be moved on the panel until reaching an obstacle, separating the first service surface from a second service surface. According to some embodiments, sensors, 110 or 120 located on mobile service device may detect the obstacle in advance. According to other embodiments, the obstacle, such as a barrier or a gap, may be detected when the mobile service device reaches the obstacle.

In step 1015 the first pull chamber may be detached from first service surface while maintaining, and optionally adjusting, e.g., by a pump controlled by a controller, the pull force applied by at least a second pull chamber. For example, when the first pull chamber is detached from the surface, the pull force applied by at least a second pull chamber may be increased by the controller.

In step 1020 mobile service device 100 or 200 may be moved until the first pull chamber reaches the second service surface.

In step 1025, the first pull chamber 130 or 230 may be actively adhered to the second service surface and in step 1030 the mobile service device may move until the one or more second pull chambers reach the second service surface.

In step 1030 the one or more second pull chambers may be adhered to the second service surface. In some embodiments, a pull force of the one or more second pull chambers may be increased, while a first pull chamber is detached from the first service surface.

In some embodiments, the method may include controlling of at least one spring, comprised in the mobile service device, in order to control a stroke displacement of the one or more pull chambers. In some embodiments, a controller such as controller 90 may control actuators 150 or 250 to control a stroke of springs 142/242.

In some embodiments, the method may further include controlling at least one pump 120 or 220, in fluid connection to the one or more pull chambers, in order to induce suction on the one or more service surfaces. For example, pumps 120 or 220 may be controlled based on gap distance as measured by sensors 110 or 210. In yet another example, pumps 120 or 220 may be controlled based chamber orientation (i.e., chambers over a gap) as measured by sensors 110 or 210.

According to some embodiments, the first pull chamber may be detached from the surface of the panel by any one of the obstacle overcoming elements or mechanisms described above with reference to FIGS. 2, 3, 4, 5, 7 and 8.

At step 1020, the mobile service device may proceed moving until the obstacle is completely overcome by the first chamber and the first pull chamber may be re-attached to a surface from the other side of the obstacle.

According to some embodiments, the mobile service device may carry on moving at the same direction until at least a second pull chamber reaches the obstacle. At step 1025, once the second pull chamber reaches the obstacle, the pull force applied by at least the first pull chamber may be maintained or adjusted (e.g., increased) during the passage of the second chamber over the obstacle.

Unless explicitly stated, the method embodiments described herein are not constrained to a particular order in time or chronological sequence. Additionally, some of the described method elements may be skipped, or they may be repeated, during a sequence of operations of a method.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A mobile service device for servicing surfaces, comprising:
at least two movable pull chambers spaced apart from each other, and
at least one obstacle overcoming element connected to each movable pull chamber,
wherein the movable pull chambers are capable of moving in a direction normal to a service surface.

2. The mobile service device of claim 1, wherein the at least one obstacle overcoming element is configured to guide a respective pull chamber along the normal direction, during a vaulting of an obstacle.

3. The mobile service device of claim 1, further comprising at least one vacuum pump in fluid connection to the at least two pull chambers, wherein the at least one vacuum pump is configured to pull the mobile service device towards the service surface.

4. The mobile service device of claim 3, wherein the at least one vacuum pump is configured to induce a negative pressure on the service surface via the pull chambers, in order to pull the mobile service device towards the service surface.

5. The mobile service device of claim 1, wherein each obstacle overcoming element comprises:
a rim, circumferentially located around an edge of the respective pull chamber.

6. The mobile service device of claim 5, wherein each rim comprises a tube, configured to change a physical property of the rim.

7. The mobile service device of claim 6, further comprising at least one inflation pump in fluid connection to the one or more tubes, wherein the at least one inflation pump is configured to change a pressure characteristic of the one or more tubes.

8. The mobile service device of claim 5, wherein the rim further comprises a sloped edge located at a front of the rim, wherein the sloped edge is set at a positive angle with respect to a motion direction of the mobile service device.

9. The mobile service device of claim 8, wherein each rim is connected to a spring, configured to direct the rim toward the service surface.

10. The mobile service device of claim 9, wherein the spring is connected to a lower surface of a chassis of the service device.

11. The mobile service device of claim 9, wherein the spring is connected to a body of the service device, wherein the chassis comprises an opening for each pull chamber, in order to allow independent movement thereof with respect to the normal direction.

12. The mobile service device of claim 1, further comprising at least one sensor configured to detect at least one of: a gap between panels of a service surface, an orientation of the mobile service device, an orientation of the pull chambers.

13. (canceled)

14. The mobile service device of claim 1, further comprising a controller, configured to perform at least one of: actuating a pull force of the pull chambers, and controlling at least one vacuum pump in fluid connection to the pull chambers.

15. The mobile service device of claim 9, wherein the each of the at least two pull chambers comprises:
a first state, comprising a first predefined distance from the serviced surface; and
a second state, comprising a second predefined distance from the serviced surface.

16. The mobile service device of claim 15, wherein actuating between the first and second states is achieved by at least one of: actuating one or more actuators configured to actuate the one or more springs, and inducing a negative pressure on the surface via the pull chambers.

17. The mobile service device of claim 15, wherein the first predefined distance is greater than zero, and the second predefined distance is equal to zero.

18. The mobile service device of claim 15, wherein the first predefined distance is equal to zero, and the second predefined distance is greater than zero.

19. The mobile service device of claim 1, further comprising a service unit.

20. The mobile service device according to claim 19, further comprising a mobility unit, configured to move the mobile service device.

21. (canceled)

22. A method of servicing a surface by a mobile service device, the method comprising:
adhering the mobile service device to a panel of a first service surface, via at least two pull chambers of the mobile service device;
moving the mobile service device on the panel until reaching an obstacle, separating the first service surface from a second service surface;
detaching a first pull chamber from the first service surface;
moving the mobile service device until the first pull chamber reaches the second service surface;
adhering the first pull chamber to the second service surface;
moving the mobile service device until the one or more second pull chambers reach the second service surface; and
adhering the one or more second pull chambers to the second service surface.

23.-53. (canceled)
